(19) United States
(12) Patent Application Publication
(10) Pub. No.: US 2025/0329857 A1
(43) Pub. Date: Oct. 23, 2025

(54) POWER STORAGE DEVICE

(71) Applicant: TOYOTA JIDOSHA KABUSHIKI KAISHA, Aichi-ken (JP)

(72) Inventors: Shigeyuki INOUE, Toyota-shi (JP); Naoya KAWAMOTO, Nisshin-shi (JP); Takahito SAKURABA, Seto-shi (JP); Kenichi KAKISHITA, Nagoya-shi (JP); Kohei TAKASE, Susono-shi (JP); Kai MIYAMURA, Toyota-shi (JP); Kazuya KUMAZAWA, Nagoya-shi (JP)

(21) Appl. No.: 19/171,350

(22) Filed: Apr. 7, 2025

(30) Foreign Application Priority Data
Apr. 18, 2024 (JP) 2024-067309

(51) Int. Cl. H01M 50/289; B60L 50/64; H01M 50/209; H01M 50/249; H01M 50/271

(52) U.S. Cl. CPC H01M 50/289; H01M 50/209; H01M 50/249; H01M 50/271; B60L 50/64; H01M 2220/20

(57) ABSTRACT

A power storage device is mountable on a vehicle, and includes: a plurality of cells; a buffer portion; and an upper plate portion. The plurality of cells are arranged in a first direction, the first direction being a direction along a horizontal direction. The buffer portion is joined to an upper portion of each of the plurality of cells. The buffer portion extends in the first direction. The upper plate portion is disposed above the buffer portion. The upper plate portion is joined to the buffer portion. The buffer portion is separable in an up-down direction when a tensile stress in the up-down direction occurs. The buffer portion includes a starting point portion. The starting point portion serves as a starting point of separation of the buffer portion at an end edge in the first direction.

### CROSS REFERENCE TO RELATED APPLICATIONS

This nonprovisional application is based on Japanese Patent Application No. 2024-067309 filed on Apr. 18, 2024, with the Japan Patent Office, the entire contents of which are hereby incorporated by reference.

### BACKGROUND

### Field

The present disclosure relates to a power storage device.

### Description of the Background Art

Japanese Patent Laying-Open No. 2020-142589 discloses that a battery pack is disposed on the lower side of a floor panel.

### SUMMARY

A structure of a power storage device mountable on a vehicle, which can achieve higher energy density of the power storage device, has been considered. For example, it has been considered to dispose a power storage device below a floor panel and as close as possible to the floor panel, or to cause a power storage device itself to constitute a part of a floor panel. However, when the power storage device is designed as described above, a load may be input from above the power storage device due to a load from the inside of a vehicle compartment, i.e., a load from the upper side. When the power storage device is designed to include a structure that increases the rigidity against input of the load, it may become difficult to disassemble the power storage device from the upper side at the time of maintenance.

The present disclosure has been made in view of the above-described problem, and an object of the present disclosure is to provide a power storage device that is high in rigidity against input of a load from above and can be easily disassembled.

A power storage device according to an aspect of the present disclosure is mountable on a vehicle. The power storage device includes: a plurality of cells; a buffer portion; and an upper plate portion. The plurality of cells are arranged in a first direction, the first direction being a direction along a horizontal direction. The buffer portion is joined to an upper portion of each of the plurality of cells. The buffer portion extends in the first direction. The upper plate portion is disposed above the buffer portion. The upper plate portion is joined to the buffer portion. The buffer portion is separable in an up-down direction when a tensile stress in the up-down direction occurs. The buffer portion includes a starting point portion. The starting point portion serves as a starting point of separation of the buffer portion at an end edge in the first direction.

In the power storage device according to the aspect of the present disclosure, preferably, the buffer portion includes, as the starting point portion, an opening facing in the first direction.

In the power storage device according to the aspect of the present disclosure, preferably, the buffer portion includes a plurality of cavity portions arranged in the first direction.

In the power storage device according to the aspect of the present disclosure, preferably, the buffer portion includes, as the starting point portion, a slit portion extending from the end edge toward an inside.

In the power storage device according to the aspect of the present disclosure, preferably, the buffer portion includes a lower-side buffer portion and an upper-side buffer portion. The lower-side buffer portion is located below the slit portion. The upper-side buffer portion is located above the slit portion. The upper-side buffer portion includes an engagement portion. The engagement portion is engaged with the lower-side buffer portion such that the engagement portion is disengaged from the lower-side buffer portion when the upper-side buffer portion is pulled upward.

In the power storage device according to the aspect of the present disclosure, preferably, the buffer portion includes: a plate-shaped main body portion; and a bonding material layer. The main body portion extends in the first direction. The bonding material layer joins the main body portion and the upper plate portion to each other. The bonding material layer includes a strong bonding portion and a weak bonding portion. The weak bonding portion as the starting point portion joins the main body portion and the upper plate portion to each other with a joining strength lower than that of the strong bonding portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a vehicle on which a power storage device according to a first embodiment of the present disclosure is mounted.

FIG. 2 is a schematic perspective view showing a vehicle body of the vehicle on which the power storage device according to the first embodiment of the present disclosure is mounted.

FIG. 3 is a schematic cross-sectional view of a part of the vehicle in FIG. 1 when viewed in the direction of an arrow III-III.

FIG. 4 is a plan view showing the power storage device according to the first embodiment of the present disclosure together with cross members of the vehicle body.

FIG. 5 is an exploded perspective view showing the power storage device according to the first embodiment of the present disclosure.

FIG. 6 is a cross-sectional view of the power storage device in FIG. 4 when viewed in the direction of an arrow VI-VI.

FIG. 7 is a schematic cross-sectional view of a power storage module.

FIG. 8 is a schematic cross-sectional view of the power storage device in FIG. 4 when viewed in the direction of an arrow VIII-VIII.

FIG. 9 is a partial cross-sectional view showing the power storage device in a state where a tensile stress in an up-down direction has occurred in a buffer portion in the first embodiment.

FIG. 10 is a partial cross-sectional view showing the power storage device in a state where the tensile stress in the up-down direction has further occurred in the buffer portion after the state shown in FIG. 9.

FIG. 11 is a partial cross-sectional view of a power storage device according to a second embodiment of the present disclosure.

FIG. 12 is a partial cross-sectional view showing the power storage device in a state where a tensile stress in the up-down direction has occurred in a buffer portion in the second embodiment.

FIG. 13 is a partial cross-sectional view of a power storage device according to a third embodiment of the present disclosure.

FIG. 14 is a partial cross-sectional view showing the power storage device in a state where a tensile stress in the up-down direction has occurred in a buffer portion in the third embodiment.

FIG. 15 is a partial cross-sectional view showing the power storage device in a state where the tensile stress in the up-down direction has further occurred in the buffer portion after the state shown in FIG. 14.

### DESCRIPTION OF THE PREFERRED EMBODIMENTS

Hereinafter, a power storage device according to each embodiment of the present disclosure will be described with reference to the drawings. In the following drawings, the same or corresponding portions are denoted by the same reference characters and description thereof will not be repeated.

### First Embodiment

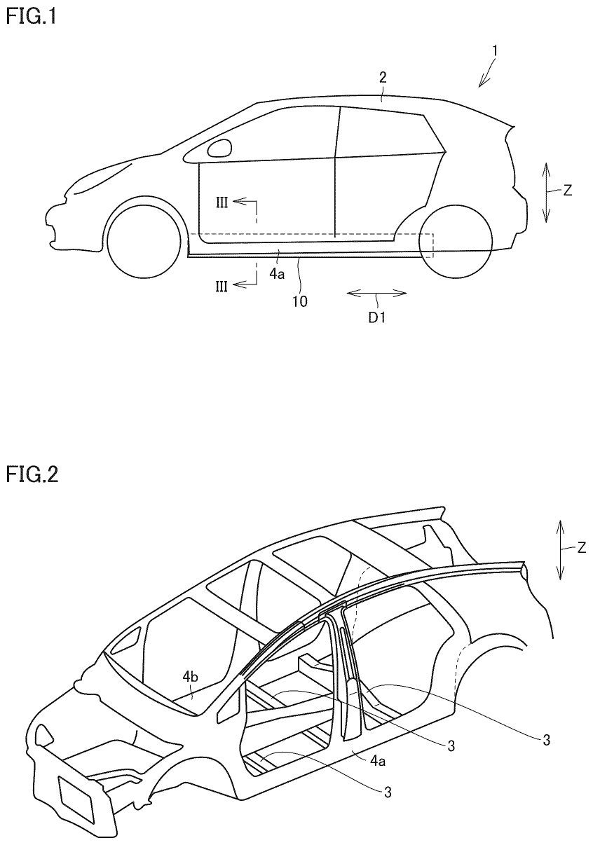

FIG. 1 is a schematic view showing a vehicle on which a power storage device according to a first embodiment of the present disclosure is mounted. As shown in FIG. 1, a power storage device 10 according to the first embodiment of the present disclosure is a power storage device mountable on a vehicle 1. Vehicle 1 will be described first.

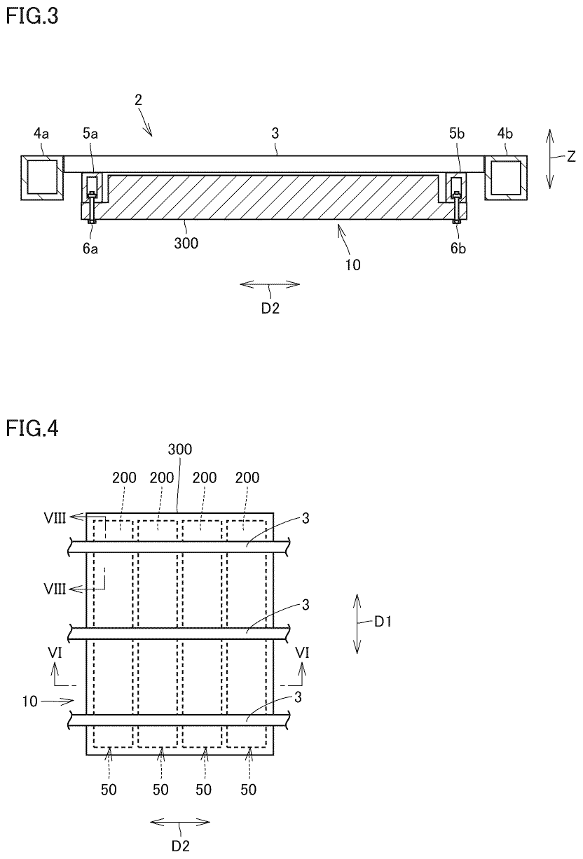

Vehicle 1 according to the first embodiment is, for example, an electrically powered vehicle such as an electric vehicle or a hybrid vehicle that can be driven by a motor. FIG. 2 is a schematic perspective view showing a vehicle body of the vehicle on which the power storage device according to the first embodiment of the present disclosure is mounted. FIG. 3 is a schematic cross-sectional view of a part of the vehicle in FIG. 1 when viewed in the direction of an arrow III-III. As shown in FIGS. 1 to 3, vehicle 1 according to the first embodiment of the present disclosure includes power storage device 10 and a vehicle body 2 to which power storage device 10 is fixed. A front-rear direction of vehicle 1 or vehicle body 2 is parallel to a below-described first direction D1 in power storage device 10.

Vehicle body 2 includes, as frame members of vehicle 1, a plurality of cross members 3, a left side sill 4a, a right side sill 4b, a left side member 5a, and a right side member 5b.

Each of the plurality of cross members 3 extends in a left-right direction of vehicle body 2. The left-right direction or a vehicle width direction of vehicle 1 or vehicle body 2 is parallel to a below-described second direction D2 in power storage device 10. The plurality of cross members 3 are arranged in first direction D1. Vehicle body 2 may include only one cross member 3.

Left side sill 4a is disposed on the left side in the left-right direction of vehicle 1. Left side sill 4a extends in the front-rear direction of vehicle 1. Right side sill 4b is disposed on the right side in the left-right direction of vehicle 1. Right side sill 4b extends in the front-rear direction of vehicle 1. Each of the plurality of cross members 3 extends from the inner side of left side sill 4a to the inner side of right side sill 4b.

Left side member 5a is disposed on the left side in the left-right direction of vehicle 1. Left side member 5a extends in the front-rear direction of the vehicle. Left side member 5a is disposed closer to the vehicle center in the vehicle width direction than left side sill 4a. Right side member 5b is disposed on the right side in the left-right direction of vehicle 1. Right side member 5b is disposed closer to the vehicle center in the vehicle width direction than right side sill 4b.

Details of power storage device 10 according to the first embodiment of the present disclosure will now be described. FIG. 4 is a plan view showing the power storage device according to the first embodiment of the present disclosure together with the cross members of the vehicle body.

As shown in FIGS. 3 and 4, power storage device 10 includes a plurality of power storage modules 50. The plurality of power storage modules 50 are disposed below cross members 3.

Each of the plurality of power storage modules 50 extends in first direction D1. First direction D1 is a direction along a horizontal direction. When viewed in an up-down direction Z, each of the plurality of power storage modules 50 is disposed to intersect at least one cross member 3. When viewed in up-down direction Z, each of the plurality of power storage modules 50 is disposed to intersect the plurality of cross members 3. The plurality of power storage modules 50 are arranged in second direction D2. Second direction D2 is a direction along the horizontal direction. Second direction D2 is a direction orthogonal to first direction D1. In the present embodiment, the plurality of power storage modules 50 are arranged only in second direction D2.

Power storage device 10 may include at least one power storage module 50. Power storage device 10 may include only one power storage module 50. The plurality of power storage modules 50 may be arranged in first direction D1. The plurality of power storage modules 50 may be arranged in first direction D1 and arranged in second direction D2. The plurality of power storage modules 50 may be arranged only in first direction D1.

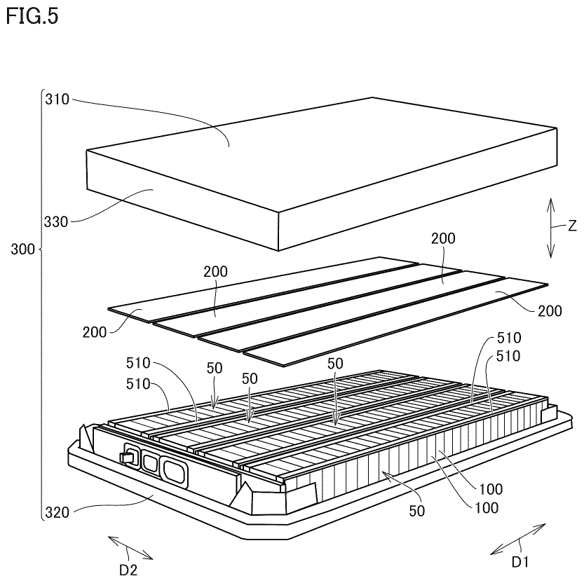

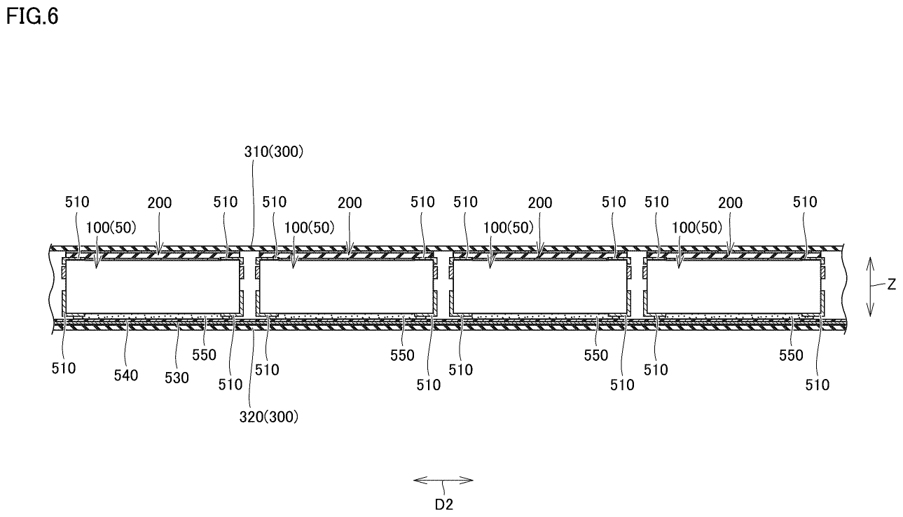

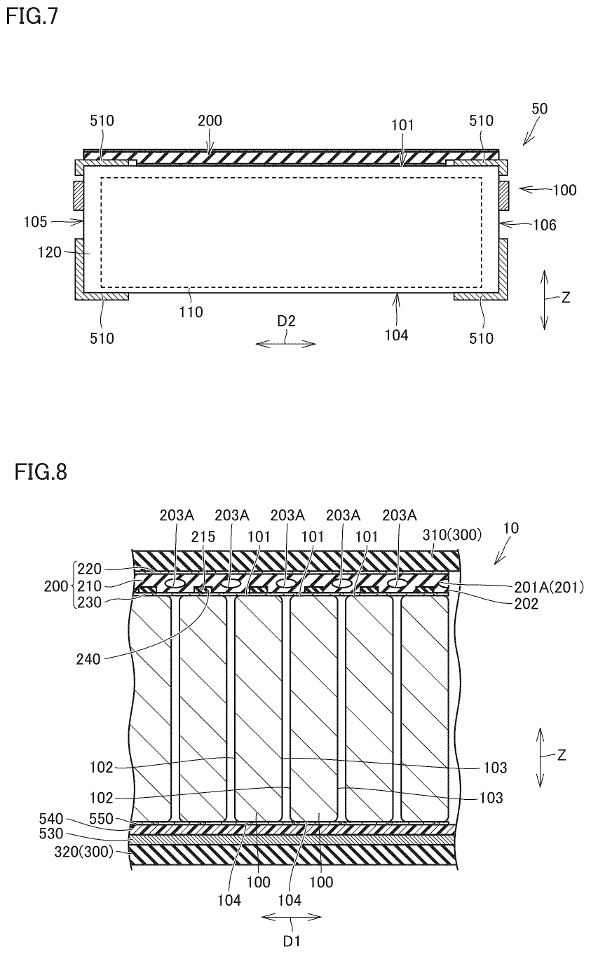

Next, details of power storage modules 50 will be described. FIG. 5 is an exploded perspective view showing the power storage device according to the first embodiment of the present disclosure. FIG. 6 is a cross-sectional view of the power storage device in FIG. 4 when viewed in the direction of an arrow VI-VI. FIG. 7 is a schematic cross-sectional view of the power storage module. FIG. 7 is illustrated in the same cross-sectional view as FIG. 6. FIG. 8 is a schematic cross-sectional view of the power storage device in FIG. 4 when viewed in the direction of an arrow VIII-VIII.

As shown in FIGS. 5 to 8, each of the plurality of power storage modules 50 includes a plurality of cells 100 and a buffer portion 200.

Each of the plurality of cells 100 is, for example, a non-aqueous electrolyte secondary battery such as a lithium ion secondary battery. The plurality of cells 100 are arranged in first direction D1, first direction D1 being a direction along the horizontal direction.

Each of the plurality of cells 100 has an upper portion 101 facing upward. Each of the plurality of cells 100 further has a first end surface portion 102, a second end surface portion 103, a bottom surface portion 104, a first side surface portion 105, and a second side surface portion 106.

First end surface portion 102 extends downward from one end edge of upper portion 101 in first direction D1. Second end surface portion 103 extends downward from the other end edge of upper portion 101 in first direction D1. Bottom surface portion 104 is located opposite to upper portion 101. Bottom surface portion 104 is connected to first end surface portion 102 and second end surface portion 103.

First side surface portion 105 faces one side in second direction D2. Second side surface portion 106 faces the other side in second direction D2. First side surface portion 105 and second side surface portion 106 are connected to upper portion 101, first end surface portion 102, second end surface portion 103, and bottom surface portion 104.

Each of the plurality of cells 100 includes an electrode assembly 110 and a cell case 120. Electrode assembly 110 includes a positive electrode layer, a negative electrode layer and a separator (all are not shown). The separator is interposed between the positive electrode layer and the negative electrode layer. The positive electrode layer and the negative electrode layer may be stacked in first direction D1 with the separator interposed therebetween. The positive electrode layer and the negative electrode layer may be wound with second direction D2 as an axial direction, in a state where the separator is interposed therebetween.

Cell case 120 houses electrode assembly 110. Cell case 120 may be made of metal such as aluminum or an aluminum alloy. Cell case 120 constitutes at least a part of each of upper portion 101, first end surface portion 102, second end surface portion 103, and bottom surface portion 104. Cell case 120 has a so-called rectangular shape.

Buffer portion 200 extends in first direction D1. When viewed in up-down direction Z, buffer portion 200 intersects the plurality of cross members 3. Buffer portion 200 is joined to upper portion 101 of each of the plurality of cells 100.

Buffer portion 200 has a starting point portion 201, an end edge 202 and a plurality of cavity portions 203A. Starting point portion 201 will be described below. End edge 202 is located at one end of buffer portion 200 in first direction D1. The plurality of cavity portions 203A are arranged in first direction D1. The plurality of cavity portions 203A may communicate with each other, or may be independent of each other. Each of the plurality of cavity portions 203A may extend in second direction D2.

Buffer portion 200 includes a main body portion 210, a first bonding material layer 220 and a second bonding material layer 230. Main body portion 210 is provided to cover the plurality of cells 100. Main body portion 210 has a substantially plate-like outer shape. Main body portion 210 extends in first direction D1. Examples of main body portion 210 include a surface pressure distribution board and the like. In the present embodiment, starting point portion 201, end edge 202 and the plurality of cavity portions 203A are formed in main body portion 210. A material of main body portion 210 will be described below.

A plurality of recessed strip portions 215 may be formed in a lower surface of main body portion 210. The plurality of recessed strip portions 215 may be provided to face a part of upper portions 101 of the plurality of cells 100, respectively.

First bonding material layer 220 is provided on an upper surface of main body portion 210. Second bonding material layer 230 is provided on the lower surface of main body portion 210. Buffer portion 200 is joined to the plurality of cells 100 by second bonding material layer 230. That is, main body portion 210 and the plurality of cells 100 are bonded to each other with second bonding material layer 230 interposed therebetween.

Buffer portion 200 may further include a plurality of elastic members 240. Each of the plurality of elastic members 240 is made of an insulating rubber material, for example. The plurality of elastic members 240 are provided within the plurality of recessed strip portions 215, respectively. The plurality of elastic members 240 are bonded to a part of upper portions 101 of the plurality of cells 100, respectively, with second bonding material layer 230 interposed therebetween.

Power storage device 10 further includes a pack 300. Pack 300 houses the plurality of cells 100 and buffer portion 200. That is, pack 300 houses the plurality of power storage modules 50. Pack 300 is fixable to vehicle body 2 of vehicle 1. Specifically, pack 300 is configured to be fixable to the frame members of vehicle body 2 of vehicle 1.

As shown in FIG. 3, in vehicle 1 according to the present embodiment, an end portion of pack 300 on one side in second direction D2 is fixed to left side member 5a by a first fastening member 6a such as a bolt. An end portion of pack 300 on the other side in second direction D2 is fixed to right side member 5b by a second fastening member 6b such as a bolt.

The end portion of pack 300 on one side in second direction D2 may be fixed to left side sill 4a. The end portion of pack 300 on the other side in second direction D2 may be fixed to right side sill 4b.

As shown in FIGS. 3 and 4, pack 300 is disposed below the plurality of cross members 3. Pack 300 extends in first direction D1. When viewed in up-down direction Z, pack 300 is disposed to intersect the plurality of cross members 3. Pack 300 also functions as a floor member that defines a vehicle compartment.

As shown in FIGS. 5 and 6, pack 300 includes an upper plate portion 310, a lower plate portion 320 and a peripheral wall portion 330. Upper plate portion 310 is disposed further above a plurality of buffer portions 200. Upper plate portion 310 is joined to buffer portions 200. Specifically, first bonding material layer 220 joins main body portion 210 and upper plate portion 310 to each other.

Lower plate portion 320 is disposed below power storage modules 50. Peripheral wall portion 330 extends downward from an outer perimeter end of upper plate portion 310. Peripheral wall portion 330 extends along the horizontal direction to surround the plurality of power storage modules 50. Peripheral wall portion 330 is connected to lower plate portion 320.

The material of main body portion 210 of buffer portion 200 will now be described. In the present embodiment, main body portion 210 is made of a material that is higher in rigidity than a material of upper plate portion 310.

The specific material of main body portion 210 is not particularly limited. Main body portion 210 is preferably a resin member, for example. The resin member is preferably higher in heat resistance temperature than the material of upper plate portion 310. The resin member is preferably lower in thermal conductivity than the material of upper plate portion 310. Since the resin member is such a material, an increase in temperature in the vehicle compartment when power storage modules 50 generate heat abnormally can be suppressed.

The resin member that constitutes main body portion 210 may include a thermosetting resin. The resin member may be made of glass fiber reinforced plastic. The resin member may include a foaming resin. The heat resistance temperature of the foaming resin is preferably equal to or higher than 400° C.

Power storage device 10 may further include a plurality of restraint members 510 in each of the plurality of power storage modules 50. The plurality of restraint members 510 extend from one side to the other side of power storage module 50 in first direction D1. A load is applied to the plurality of cells 100 in first direction D1 by the plurality of restraint members 510. Relative positions of the plurality of cells 100 are fixed to each other by the plurality of restraint members 510. Each of the plurality of restraint members 510 covers four corners of each of the plurality of cells 100 when viewed in first direction D1.

Power storage device 10 may further include a cooling plate 530. Cooling plate 530 is provided below the plurality of power storage modules 50. Cooling plate 530 may be provided above the plurality of power storage modules 50. A flow circuit (not shown) in which refrigerant such as air or a cooling liquid can flow is formed inside cooing plate 530.

Power storage device 10 may further include a tray 540. Tray 540 is provided below the plurality of power storage modules 50. Power storage device 10 may further include a third bonding material layer 550 in each of the plurality of power storage modules 50. Third bonding material layer 550 is disposed between the plurality of cells 100 and tray 540. Third bonding material layer 550 joins the plurality of cells 100 to tray 540.

Although the plurality of cells 100 are spaced apart from each other as shown in FIG. 8 for ease of description, the plurality of cells 100 may be in close contact with each other in first direction D1. Another member such as a spacer may be interposed between the plurality of cells 100.

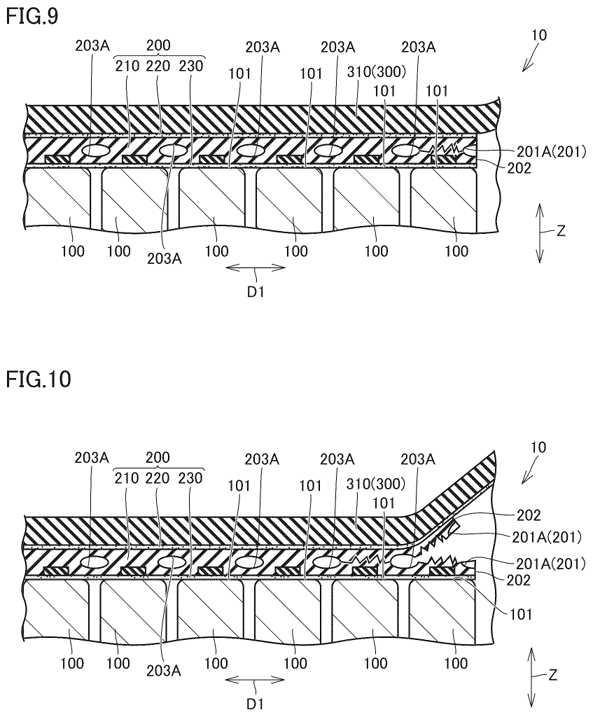

Starting point portion 201 of buffer portion 200 in the first embodiment will now be further described. FIG. 9 is a partial cross-sectional view showing the power storage device in a state where a tensile stress in the up-down direction has occurred in the buffer portion in the first embodiment. FIG. 10 is a partial cross-sectional view showing the power storage device in a state where the tensile stress in the up-down direction has further occurred in the buffer portion after the state shown in FIG. 9. In FIGS. 9 and 10, power storage device 10 is partially illustrated in the same cross-sectional view as FIG. 8.

As shown in FIGS. 8 to 10, buffer portion 200 is configured to be separable in up-down direction Z when the tensile stress in up-down direction Z occurs. In the present embodiment, this separation is caused by breaking. Specifically, FIGS. 8 to 10 show a change in state when upper plate portion 310 is torn off from the plurality of cells 100. More specifically, FIGS. 8 to 10 show a change in state when upper plate portion 310 is pulled upward from the vicinity of end edge 202 of buffer portion 200.

Starting point portion 201 serves as a starting point of separation of buffer portion 200 at end edge 202 in first direction D1. In the present embodiment, buffer portion 200 has, as starting point portion 201, opening 201A facing in first direction D1. Opening 201A may extend in second direction D2 orthogonal to first direction D1. As shown in FIGS. 8 to 10, the above-described pulling causes a crack from opening 201A toward the inside of buffer portion 200 along first direction D1. This causes main body portion 210 of buffer portion 200 to be separated in up-down direction Z. As a result, upper plate portion 310 is torn off from the plurality of cells 100.

As described above, power storage device 10 according to the first embodiment of the present disclosure is mountable on vehicle 1. Power storage device 10 includes: a plurality of cells 100; buffer portion 200; and upper plate portion 310. The plurality of cells 100 are arranged in first direction D1, first direction D1 being a direction along a horizontal direction. Buffer portion 200 is joined to upper portion 101 of each of the plurality of cells 100. Buffer portion 200 extends in first direction D1. Upper plate portion 310 is disposed above buffer portion 200. Upper plate portion 310 is joined to buffer portion 200. Buffer portion 200 is separable in up-down direction Z when a tensile stress in up-down direction Z occurs. Buffer portion 200 includes starting point portion 201. Starting point portion 201 serves as a starting point of separation of buffer portion 200 at end edge 202 in first direction D1.

According to the above-described configuration, input of a load from above power storage device 10 can be distributed in first direction D1 in buffer portion 200, and thus, the rigidity of power storage device 10 against input of the load from above can be increased. In addition, at the time of maintenance and the like, an operator tries to separate upper plate portion 310 from the plurality of cells 100 by pulling the end of upper plate portion 310 upward. At this time, buffer portion 200 is separated in up-down direction Z with above-described starting point portion 201 as a starting point (see FIGS. 9 to 11), and thus, upper plate portion 310 can be easily separated from the plurality of cells 100. Therefore, according to the above-described configuration, it is possible to provide power storage device 10 that is high in rigidity against input of the load from above and can be easily disassembled.

In addition, in the first embodiment, buffer portion 200 includes, as starting point portion 201, opening 201A facing in first direction D1. According to the above-described configuration, when the end of upper plate portion 310 is pulled upward, a crack is likely to occur from opening 201A toward the inside of buffer portion 200 along first direction D1 (see FIGS. 9 to 11). As a result, buffer portion 200 can be more easily separated in up-down direction Z.

In addition, in the first embodiment, buffer portion 200 includes a plurality of cavity portions 203A arranged in first direction D1. According to the above-described configuration, when the end of upper plate portion 310 is pulled upward, a crack is likely to occur inside buffer portion 200 in a region from opening 201A to cavity portion 203A and in a region between cavity portions 203A (see FIGS. 9 to 11). As a result, buffer portion 200 can be more easily separated in up-down direction Z.

### Second Embodiment

Next, a power storage device according to a second embodiment of the present disclosure will be described. The power storage device according to the second embodiment of the present disclosure is different from power storage device 10 according to the first embodiment of the present disclosure mainly in terms of a configuration of the buffer portion. Description of the same configuration and effect as those of power storage device 10 according to the first embodiment of the present disclosure will not be repeated.

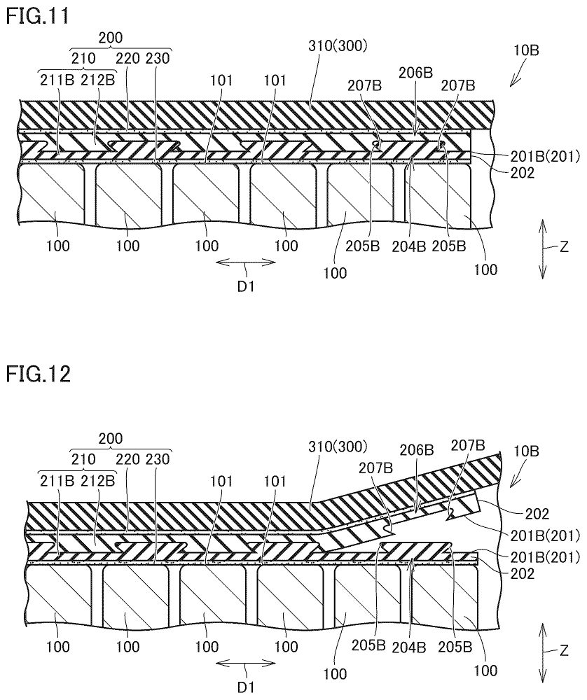

FIG. 11 is a partial cross-sectional view of the power storage device according to the second embodiment of the present disclosure. In FIG. 11 and the subsequent figures, the power storage device is illustrated in the same cross-sectional view as the cross-sectional view in the first embodiment.

As shown in FIG. 11, in a power storage device 10B according to the second embodiment of the present disclosure, buffer portion 200 has a slit portion 201B. Slit portion 201B extends from end edge 202 toward the inside. Slit portion 201B extends over entire buffer portion 200 in first direction D1.

Buffer portion 200 includes a lower-side buffer portion 204B and an upper-side buffer portion 206B. Lower-side buffer portion 204B is located below slit portion 201B. Lower-side buffer portion 204B has a plurality of engaged portions 205B. Each of the plurality of engaged portions 205B is provided to be recessed toward one side in first direction D1 in lower-side buffer portion 204B. Each of the plurality of engaged portions 205B may be provided to protrude toward one side in first direction D1 in lower-side buffer portion 204B.

Upper-side buffer portion 206B is located above slit portion 201B. Upper-side buffer portion 206B has engagement portions 207B. The plurality of engagement portions 207B are engaged with lower-side buffer portion 204B. Specifically, each of the plurality of engagement portions 207B is provided to protrude toward one side in first direction D1 in upper-side buffer portion 206B. When each of the plurality of engaged portions 205B is provided to protrude, each of the plurality of engagement portions 207B may be provided to be recessed toward one side in first direction D1 in upper-side buffer portion 206B.

In addition, in the present embodiment, main body portion 210 includes a lower-side main body portion 211B and an upper-side main body portion 212B. Lower-side main body portion 211B is a portion located on the lower side of slit portion 201B. Upper-side main body portion 212B is a portion located on the upper side of slit portion 201B. In the present embodiment, lower-side buffer portion 204B includes lower-side main body portion 211B and second bonding material layer 230. Upper-side buffer portion 206B includes upper-side main body portion 212B and first bonding material layer 220.

Starting point portion 201 of buffer portion 200 in the second embodiment will now be described. FIG. 12 is a partial cross-sectional view showing the power storage device in a state where a tensile stress in the up-down direction has occurred in the buffer portion in the second embodiment. As shown in FIGS. 11 and 12, also in the second embodiment, buffer portion 200 is configured to be separable in up-down direction Z when the tensile stress in up-down direction Z occurs. Specifically, FIGS. 11 and 12 show a change in state when upper plate portion 310 is torn off from the plurality of cells 100. More specifically, FIGS. 11 and 12 show a change in state when upper plate portion 310 is pulled upward from the vicinity of end edge 202 of buffer portion 200.

In the second embodiment, slit portion 201B functions as starting point portion 201. As shown in FIGS. 11 and 12, the above-described pulling causes upward pulling of upper-side buffer portion 206B in the vicinity of end edge 202. When upper-side buffer portion 206B is pulled upward, the plurality of engagement portions 207B are disengaged from lower-side buffer portion 204B. Specifically, the plurality of engagement portions 207B are disengaged from the plurality of engaged portions 205B. This causes main body portion 210 of buffer portion 200 to be separated in up-down direction Z. As a result, upper plate portion 310 is torn off from the plurality of cells 100.

In the present embodiment, main body portion 210 of buffer portion 200 is separated in up-down direction Z without breaking. Therefore, in power storage device 10B according to the second embodiment, lower-side buffer portion 204B and upper-side buffer portion 206B can also be easily assembled during production of power storage device 10B, for example.

As described above, in power storage device 10B according to the second embodiment of the present disclosure, buffer portion 200 includes, as starting point portion 201, slit portion 201B extending from end edge 202 toward the inside.

According to the above-described configuration, when the end of upper plate portion 310 is pulled upward, buffer portion 200 can be easily separated in up-down direction Z along slit portion 201B.

In addition, in the second embodiment, buffer portion 200 includes lower-side buffer portion 204B and upper-side buffer portion 206B. Lower-side buffer portion 204B is located below the slit portion. Upper-side buffer portion 206B is located above the slit portion. Upper-side buffer portion 206B includes engagement portion 207B. Engagement portion 207B is engaged with lower-side buffer portion 204B such that engagement portion 207B is disengaged from lower-side buffer portion 204B when upper-side buffer portion 206B is pulled upward.

According to the above-described configuration, engagement portion 207B is engaged with lower-side buffer portion 204B during normal use other than maintenance, and thus, separation between upper-side buffer portion 206B and lower-side buffer portion 204B can be suppressed.

### Third Embodiment

Next, a power storage device according to a third embodiment of the present disclosure will be described. The power storage device according to the third embodiment of the present disclosure is different from power storage device 10 according to the first embodiment of the present disclosure mainly in terms of a configuration of the buffer portion. Description of the same configuration and effect as those of power storage device 10 according to the first embodiment of the present disclosure will not be repeated.

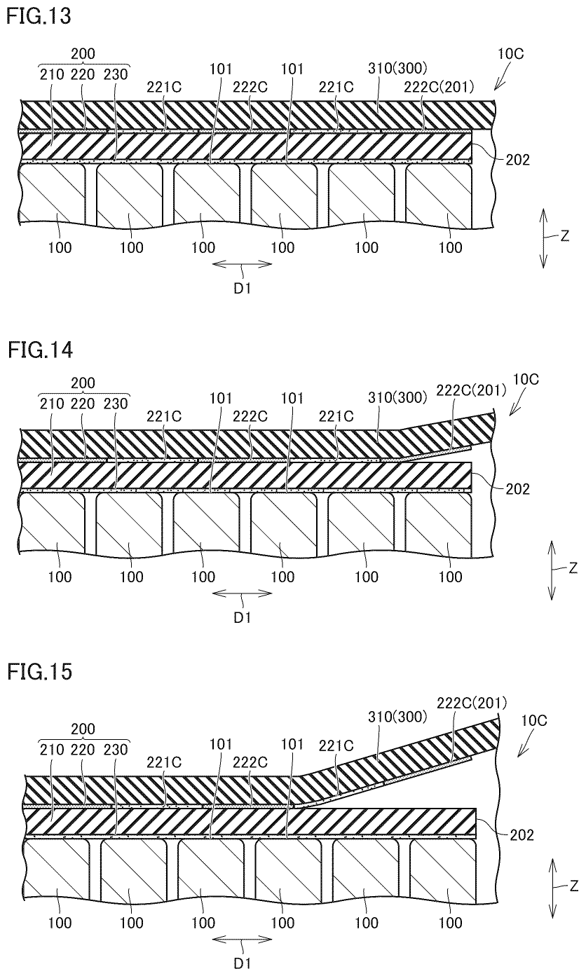

FIG. 13 is a partial cross-sectional view of the power storage device according to the third embodiment of the present disclosure. As shown in FIG. 13, in a power storage device 10C according to the third embodiment of the present disclosure, first bonding material layer 220 includes a strong bonding portion 221C and a weak bonding portion 222C. Weak bonding portion 222C as starting point portion 201 joins main body portion 210 and upper plate portion 310 to each other with a joining strength lower than that of strong bonding portion 221C.

FIG. 14 is a partial cross-sectional view showing the power storage device in a state where a tensile stress in the up-down direction has occurred in the buffer portion in the third embodiment. FIG. 15 is a partial cross-sectional view showing the power storage device in a state where the tensile stress in the up-down direction has further occurred in the buffer portion after the state shown in FIG. 14.

As shown in FIGS. 13 to 15, according to the above-described configuration, when the end of upper plate portion 310 is pulled upward, first bonding material layer 220 and main body portion 210 can be easily separated in up-down direction Z, starting from unjoining of weak bonding portion 222C from main body portion 210. During normal use other than maintenance, unjoining of first bonding material layer 220 from main body portion 210 can be suppressed by strong bonding portion 221C.

Furthermore, in the present embodiment, first bonding material layer 220 includes a plurality of strong bonding portions 221C and a plurality of weak bonding portions 222C including weak bonding portion 222C serving as above-described starting point portion 201. The plurality of strong bonding portions 221C and the plurality of weak bonding portions 222C are alternately arranged in first direction D1.

According to the above-described configuration, the ease of separation between first bonding material layer 220 and main body portion 210 and the force of joining between first bonding material layer 220 and main body portion 210 can be balanced.

In the description of the above-described embodiments, the features that can be combined may be combined mutually.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device mountable on a vehicle, the power storage device comprising:
a plurality of cells arranged in a first direction, the first direction being a direction along a horizontal direction;
a buffer portion joined to an upper portion of each of the plurality of cells and extending in the first direction; and
an upper plate portion disposed above the buffer portion and joined to the buffer portion, wherein
the buffer portion is separable in an up-down direction when a tensile stress in the up-down direction occurs, and
the buffer portion includes a starting point portion serving as a starting point of separation of the buffer portion at an end edge in the first direction.

2. The power storage device according to claim 1, wherein
the buffer portion includes, as the starting point portion, an opening facing in the first direction.

3. The power storage device according to claim 2, wherein
the buffer portion includes a plurality of cavity portions arranged in the first direction.

4. The power storage device according to claim 1, wherein
the buffer portion includes, as the starting point portion, a slit portion extending from the end edge toward an inside.

5. The power storage device according to claim 4, wherein
the buffer portion includes a lower-side buffer portion located below the slit portion, and an upper-side buffer portion located above the slit portion, and
the upper-side buffer portion includes an engagement portion that is engaged with the lower-side buffer portion such that the engagement portion is disengaged from the lower-side buffer portion when the upper-side buffer portion is pulled upward.

6. The power storage device according to claim 1, wherein
the buffer portion includes:
a plate-shaped main body portion extending in the first direction; and
a bonding material layer that joins the main body portion and the upper plate portion to each other, and
the bonding material layer includes a strong bonding portion and a weak bonding portion, the weak bonding portion as the starting point portion joining the main body portion and the upper plate portion to each other with a joining strength lower than that of the strong bonding portion.
